(19) United States
(12) Patent Application Publication
(10) Pub. No.: US 2021/0267160 A1
(43) Pub. Date: Sep. 2, 2021

(54) Feline Pet Care Vessel

(71) Applicant: Susan Harrelson, Summerville, SC (US)

(72) Inventor: Susan Harrelson, Summerville, SC (US)

(21) Appl. No.: 17/207,902

(22) Filed: Mar. 22, 2021

Related U.S. Application Data
(60) Provisional application No. 63/006,476, filed on Apr. 7, 2020.

(51) Int. Cl. A01K 1/03; A01K 1/01

(52) U.S. Cl. CPC A01K 1/033; A01K 1/0107

(57) ABSTRACT

A feline pet care vessel incorporating a first box having a first longitudinal wall, having a first open end, and having a first horizontal wall positioned oppositely from the first open end; a second box having a second longitudinal wall, having a second open end, and having a second horizontal wall positioned oppositely from the second open end, wherein the second open end receives the first open end; a first perforation line formed within the first box's longitudinal wall, the first perforation line being “U” shaped and including a web and a pair of legs extending toward the first open end; and a second perforation line formed within the second box's longitudinal wall, the second perforation line being “U” shaped and including a web and a pair of legs extending toward the second open end.

### CLAIM OF PRIORITY FROM PREVIOUSLY FILED PROVISIONAL PATENT APPLICATION

This non-provisional patent application claims the benefit of and priority from U.S. Provisional Patent Application No. 63/006,476 filed Apr. 7, 2020. The inventor disclosed in and applicant of said provisional application is the same person as the person who is disclosed as the inventor in and applicant of the instant application. The applicant asserts that structures and functions of structures disclosed and described in the instant application are substantially identical to those disclosed in said provisional application.

### FIELD OF THE INVENTION

The present invention relates to feline pet care. More specifically, the present invention relates to vessels and enclosures for feline pet care which present variously configured and variously positioned openings for cat ingress and egress.

### BACKGROUND OF THE INVENTION

Enclosed cat or feline litter boxes and sheltering enclosures are known to be provided for facilitation of indoor feline pet care. Known configurations of such feline litter boxes and enclosures are typically restricted or limited in their capacities for configuration and reconfiguration, and are limited in their capacities for alternative service in varying modes of use.

The instant inventive vessel for feline pet care solves, ameliorates, or improves upon such problems and deficiencies by providing a specially configured vessel which incorporates paired nesting boxes which include perforated line openings which create specialized tearaway box wall sections enabling variable configurations of the vessel for varying and selective modes of use by cats.

### BRIEF SUMMARY OF THE INVENTION

A first structural component of the instant inventive feline pet care vessel comprises a first box having a first longitudinal wall, a first open end, and a first horizontal wall positioned oppositely from the first open end. In a suitable embodiment, the first horizontal wall component is rectangular, such shape preferably being substantially square. In the suitable embodiment, the first box may be composed of corrugated cardboard or fiberboard.

A further structural component of the instant inventive feline pet care vessel comprises a second box having a second longitudinal wall, a second open end, and a second horizontal wall positioned oppositely from the second open end. In the suitable embodiment, the second box's second longitudinal wall and associated oppositely longitudinal and lateral wall components have vertical heights or vertical dimensions which are markedly less than those of the corresponding walls of the first box. In such embodiment, the first box nests within the second box in an orientation wherein the first box's first open end is inserted into or is received within the second box's second opened end.

A further structural component of the instant inventive feline pet care vessel comprises a first perforated line or line of perforations which is formed within or die cut within the first box's longitudinal wall. In a preferred embodiment, the perforations of the first perforated line are large enough and are sufficiently closely spaced to allow manual tearing of the wall along the line. The first perforation line preferably includes or follows a “U” shape or path, such “U” including a pair of legs and a web spanning laterally between the legs' proximal or base ends. In the suitable embodiment, such web is arcuately curved away from the box's first open end. Also in such embodiment, each of the legs extends toward and terminates at the first box's first open end.

A further structural component of the instant inventive feline pet care vessel comprises a second perforation line which is formed or die cut within the second box's longitudinal wall. The second perforated line is preferably configured similarly with the first perforated line for facilitating manual wall tearing along the line. Similarly with the first perforation line, the second perforated line has a “U” shape which includes a web which spans between base or proximal ends of such U's legs. In contrast with the arcuate curvature of the web of the first perforated line, the web portion of the second perforated line is suitably substantially straight, extending parallel to the second horizontal wall. Similarly with the extensions of the legs of the first perforated line, the legs of the second perforated line suitably extend toward and terminate at the second box's second open end.

In use of the instant inventive feline pet care vessel, a pet owner may orient the first horizontal wall downwardly, causing such wall to rest upon a floor or tabletop surface. Thereafter, the pet owner may tear the first longitudinal wall along the first perforated line, creating a “U” shaped opening within the first longitudinal wall. Thereafter, the pet owner may pour a volume of cat litter over the upwardly facing surface of the first horizontal wall, covering such wall in the manner of a floor covering layer of cat litter. Thereafter, the pet owner may place the second box downwardly over the upper opening of the first box, effectively allowing the second box to function as a sealing of the interior space of the first box. Thereafter, the pet owner's cat may utilize the vessel as an enclosed cat litter vessel. In order to prevent seepage of, and absorption of urine, interior surfaces of the vessel may be coated with a wax or polymer or waterproof coating.

In an alternative use of the instant inventive feline pet care vessel, the pet owner may additionally tearaway a section of the second box's longitudinal wall, such tearing following the second perforation line. Upon such wall section tearing, an exposed “U” shaped space within the second longitudinal wall may combine with and longitudinally overlie the “U” shaped space within the first longitudinal wall. Upon interconnecting and inverting both boxes, and upon resting the outer surface of the second horizontal wall upon a floor, tabletop, or countertop surface, the instant inventive pet care vessel advantageously alternatively functions as a feline enclosure which facilitates cat rest and sleep.

Accordingly, objects of the instant invention include the provision of a feline pet care vessel which incorporates structures, as described above, and which arranges those structures in relation to each other in manners described above, for the performance and achievement of beneficial functions, as described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a perspective view of a first box component of the instant inventive feline pet care vessel.

FIG. 2 re-depicts the structure of FIG. 1, the view of FIG. 2 further showing a second box component covering an open end of the first box component.

FIG. 3 re-depicts the structure of FIG. 2, the view of FIG. 3 showing a circular wall section torn away.

FIG. 4 presents an alternative reconfiguration of the FIG. 2 structure, the view showing a section of a longitudinal wall section removed.

FIG. 5 re-depicts the structure of FIG. 4, the view of FIG. 5 showing the structure of FIG. 4 inverted, and alternatively showing a second longitudinal wall section remove, and showing an inserted pad component.

FIG. 6 presents an alternative configuration of the FIG. 5 structure, the view of FIG. 6 showing, within a cut-away, cat litter dispersed over the pad component.

FIG. 7 re-depicts the structure of FIG. 6, the view of FIG. 7 showing first box components removed.

### DETAILED DESCRIPTION OF A PREFERRED EMBODIMENT

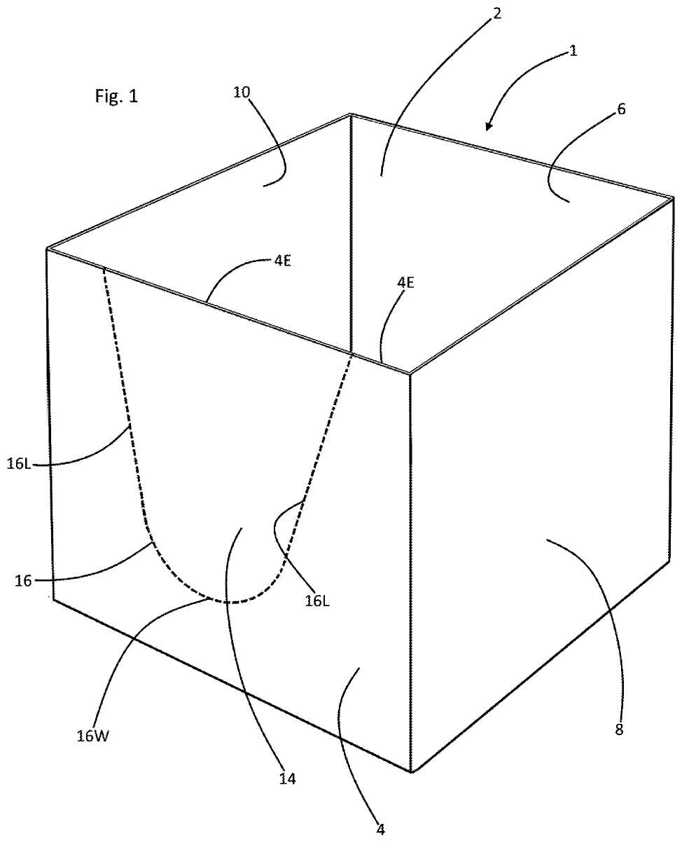

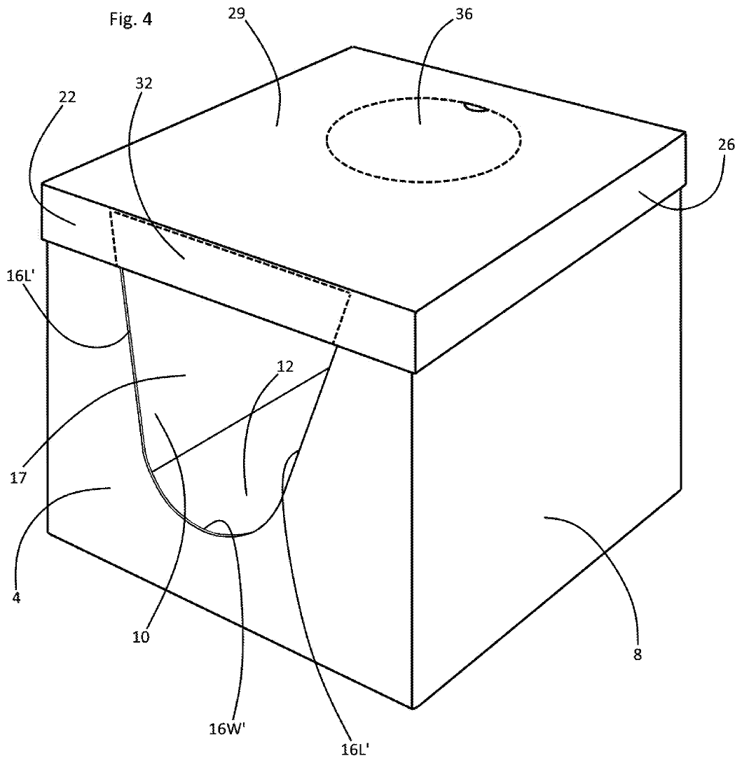

Referring now to the drawings and in particular to Drawing FIG. 1, the instant inventive feline pet care vessel suitably incorporates a first box component which is referred to generally by Reference Arrow 1. The first box component 1 has an open side or end 2, a first longitudinal wall 4, an oppositely longitudinal wall 6, a lateral wall 8, and an oppositely lateral wall 10. Referring further simultaneously to FIG. 4, the first box 1 further has a first horizontal wall 12 which is positioned oppositely from open side 2.

The first box 1 preferably includes a first substantially “U” shaped perforation line 16 which is formed or die cut within the first longitudinal wall 4. Such “U” shaped perforation line 16 has a laterally spaced pair of leg extensions 16L, and has a web extension 16W which spans between and interconnects proximal ends of said extensions. In the depicted embodiment, each leg extension 16L extends toward an open end wall edge 4E of the first longitudinal wall 4, the extreme distal ends of such legs 16L being positioned at or terminating at such edge 4E.

The inner surfaces of the first box's walls 4, 6, 8, 10, and 12 may, for purposes further explained below, be coated with a water-proofing material such as wax or a water impervious polymer.

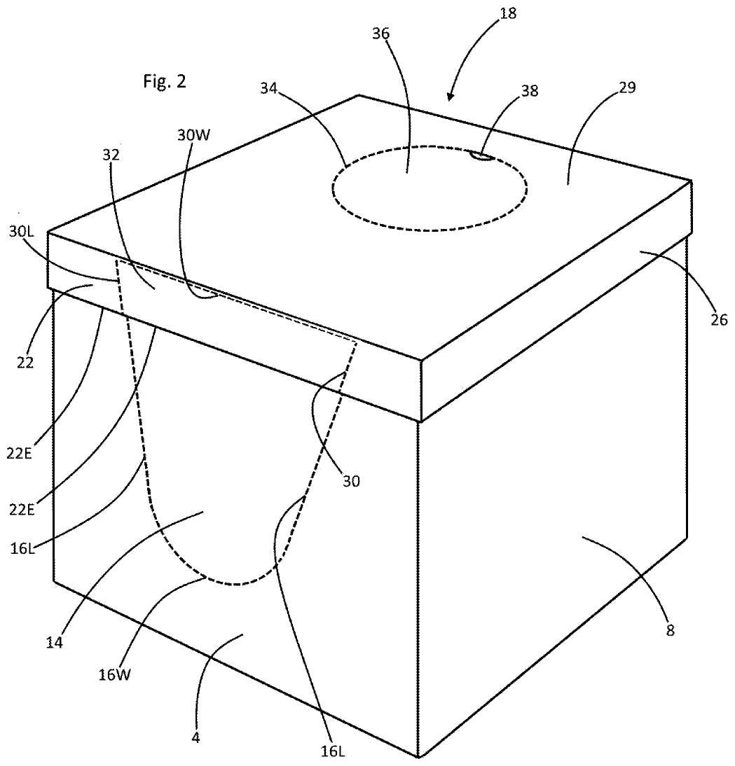

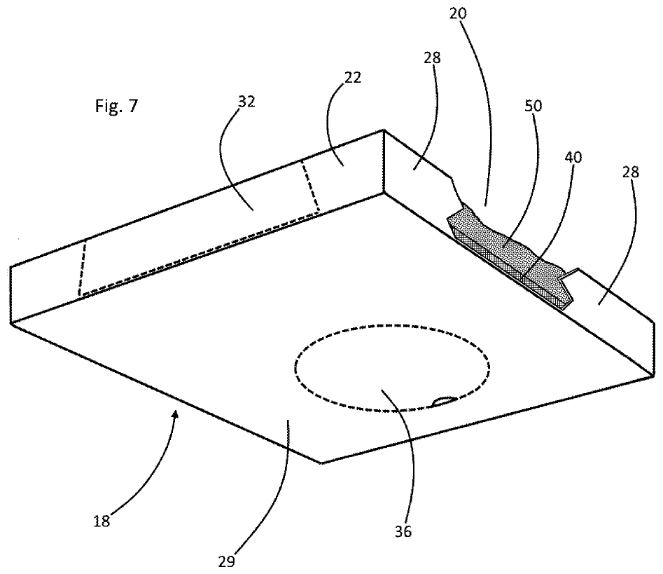

Referring simultaneously to FIGS. 2 and 7, the instant inventive vessel for pet care preferably further comprises a second box which is referred to generally by Reference Arrow 18. Similarly with the open side 2 of the first box 1, the second box 18 has an open side 20. The second box 18 further has a lateral wall 26, an oppositely lateral wall 28, a second longitudinal wall 22, a wall positioned oppositely from the second longitudinal wall 22 (such wall not being depicted within views). The second box 18 further has a second horizontal wall 29 which is positioned oppositely from the open side 20.

A second substantially “U” shaped perforation line 30 is preferably formed or die cut within the second box's second longitudinal wall 22, such second “U” shaped perforation having, similarly with the first “U” perforation line 16, a laterally spaced pair of leg portions or segments 30L, and having a web portion 30W spanning between proximal ends of such leg portions. Similarly with the first “U” perforation line's extensions of perforated legs 16L to edge 4E, distal ends of legs 30L of the second “U” perforation line 30 extend to and terminate at an open side edge 22E of the second longitudinal wall 22.

The second horizontal wall 29 of the second box 18 preferably includes or incorporates a closed loop perforation line 34, such perforations including or incorporating an enlarged finger pull aperture 38. While the closed loop perforation line 34,38 may be suitably configured to match other geometric shapes such as squares, hexagons, and pentagons, such line preferably is substantially circular.

Referring simultaneously to FIGS. 1, 2, and 7, the open side 20 of the second box 18 is preferably sized slightly larger than the open side 2 of the first box 1, such size differential allowing open side ends or edges of the first box's walls 4, 6, 8, and 10, to be inserted into and received within the second box's open side 20. Upon such insertion and receipt, a completely enclosed vessel as indicated in FIG. 2 is conveniently assembled. In the FIG. 2 configuration, the legs 30L of the second “U” shaped perforation line 30 preferably align with and longitudinally overlie the distal ends of the legs 16L of the first “U” shaped perforation line 16, the “U” shape of such perforation line 30 being inverted with respect to the “U” shape of perforation line 16.

In a suitable mode of use of the instant inventive vessel for feline care, the first box 1 may be initially placed by the pet owner upon a floor surface or upon a table top in the orientation indicated in FIG. 1. Thereafter, the pet owner may manually grasp the portion of the upturned wall edge 4E which resides between the distal ends of legs 16L. Thereafter, the pet owner may pull longitudinally against such wall edge. Such pulling force advantageously causes a wall section 14 bounded by perforation line 16 to tear away from the first longitudinal wall 4, such tearing operation progressing along the first “U” shaped perforation line 16. Such wall section tearing preferably continues until section 14 is completely removed. Thereafter, the pet owner may dispose of or recycle wall section 14.

Referring further simultaneously to FIG. 4, the above described perforated line tearing removal of wall section 14 advantageously creates a “U” shaped opening 17 having lateral edges 16L′ and having a web edge 16W′ spanning between proximal ends of such lateral edges. Following the creation of opening 17, the pet owner may invert the second box 18, causing such box to rotate 180° from its FIG. 7 orientation to the depicted FIG. 4 orientation. Thereafter, the pet owner may downwardly move the second box 18 toward the first box 1 until the first open side 2 of the first box enters and is received within the second open side 20 of the second box 18.

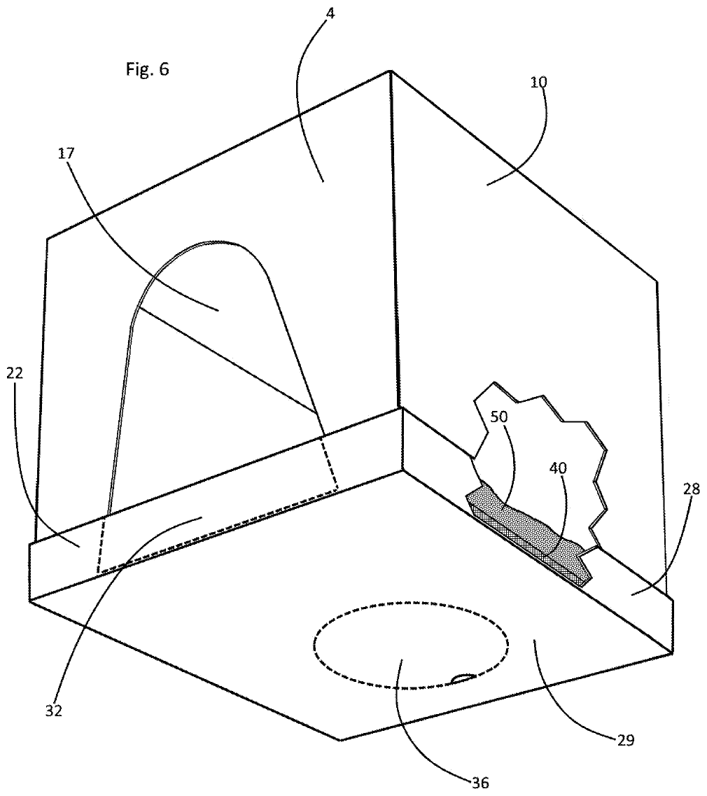

Thereafter, the pet owner may simultaneously invert the interconnected boxes 1 and 18, causing the boxes to assume the orientation of FIG. 6. Upon placement of the assembled FIG. 6 vessel at a suitable location such as a utility room floor or garage floor, a waterproof panel, mat, or pad 40 may be inserted into the interior of the box through opening 17, causing such pad 40 to co-extensively overlie the upturned surface of the second horizontal wall 29. In a suitable embodiment, the pad 40 is waterproof for prevention of fluids seepage through the perforated openings of the closed loop perforation line 34.

Thereafter, the pet owner may disperse a body of cat litter 50 into the interior of the completed vessel, such cat litter dispersion covering the upturned surface of pad 40. In the FIG. 6 configuration, the wall section 32 portion of the second longitudinal wall 22 of the second box 18 is preferably left in place in order to allow an uninterrupted lateral extension of the longitudinal wall 22 to function as a cat litter retaining dam or wall. Cats entering and exiting through opening 17 may simply step over such retaining wall 22,32 during box ingress and egress.

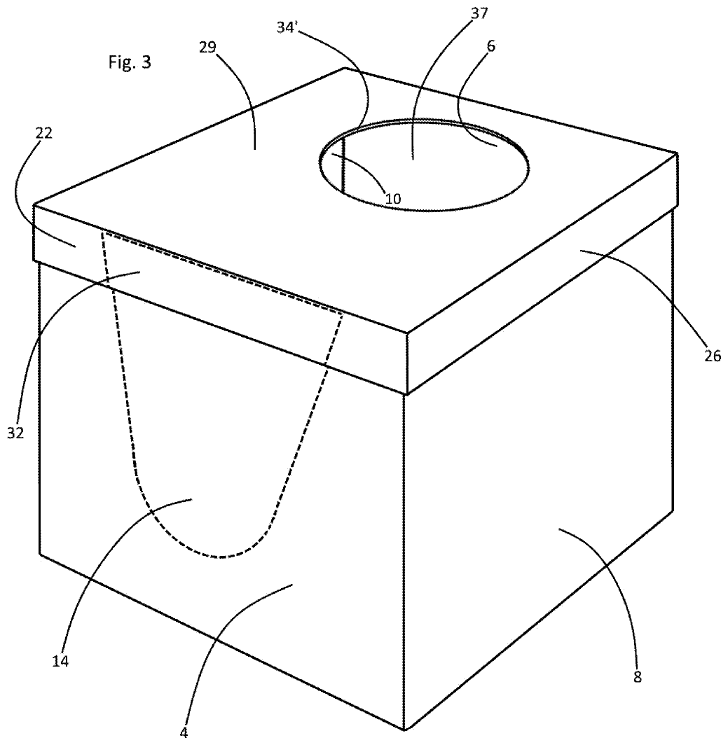

In an alternative mode of use of the instant inventive feline pet care vessel, the box components may be initially configured as indicated in Drawing FIG. 2. Thereafter, the pet owner may insert a finger into finger pull aperture 38, and may thereby pull upwardly against the peripheral edge of wall 36. Such finger pull causes wall section 36 to be removed from the second horizontal wall 29 by tearing the wall along the perforated line 34. Referring to FIG. 3, such wall section tearaway operation may advantageously create a circular feline ingress and egress aperture 37 having a peripheral edge 34′.

Referring simultaneously to FIGS. 3 and 6, and assuming that the inner surface of wall 12 is protected by a waterproof coating, a pet owner may easily and conveniently pour cat litter into and through aperture 37, covering the upturned surface of the first horizontal wall 12. Thereafter, a cat may utilize the assembled vessel as an enclosed cat litter usage space which advantageously includes an upper ingress and egress opening.

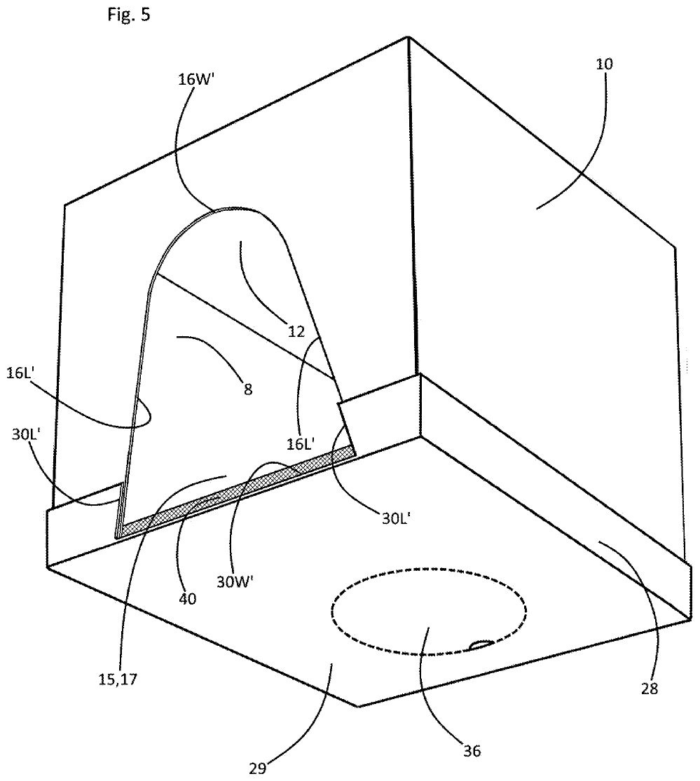

In a further alternative mode of use of the instant inventive feline pet care vessel, section 32 of the second longitudinal wall 22 of the second box 18 may be torn away along perforation line 30. Such tearaway operation advantageously exposes an ingress/egress opening 15 within the second longitudinal wall 22. Upon the tear away of wall section 32, the created opening 15 preferably coincides with the oppositely longitudinally underlying distal end of opening 17. Thereafter, the pad 40 may be inserted into and through the created opening 15,17. The pad 40 may suitably and advantageously constitute a cushion or present a cushioning surface which is suitable for use as a cat sleeping surface. Accordingly, upon achieving the alternative vessel configuration of FIG. 5, the pet care provided by the vessel additionally or alternatively performs a function of sheltering a cat during rest or sleep.

While the principles of the invention have been made clear in the above illustrative embodiment, those skilled in the art may make modifications to the structure, arrangement, portions and components of the invention without departing from those principles. Accordingly, it is intended that the description and drawings be interpreted as illustrative and not in the limiting sense, and that the invention be given a scope commensurate with the appended claims.

The invention hereby claimed is:

1. A feline pet care vessel comprising:
(a) a first box having a first longitudinal wall, a first open end, and a first horizontal wall positioned oppositely from the first open end;
(b) a second box having a second longitudinal wall, a second open end, and a second horizontal wall positioned oppositely from the second open end, wherein the first open end is received within the second open end;
(c) a first perforation line formed within the first box's longitudinal wall, said perforation line having a “U” shape including a web and a pair of legs, wherein said pair of legs extends toward the first open end; and
(d) a second perforation line formed within the second box's longitudinal wall, said perforation line having a “U” shape including a web and a pair of legs, wherein said pair of legs extends toward the second open end.

2. The feline pet care vessel of claim 1 wherein the legs of the second “U” shaped perforation line longitudinally overlie the legs of the first “U” shaped perforation line.

3. The feline pet care vessel of claim 2 wherein the first longitudinal wall has an edge at the first open end, wherein the legs of the first “U” shaped perforation line have distal ends, and wherein said leg distal ends are positioned at said edge.

4. The feline pet care vessel of claim 3 wherein the second box's longitudinal wall has an edge at the second open end, wherein the legs of the second “U” shaped perforation line have distal ends, and wherein said leg distal ends are positioned at said edge.

5. The feline pet care vessel of claim 4 further comprising a closed loop perforation line formed within a box wall selected from the group consisting of the first and second horizontal walls.

6. The feline pet care vessel of claim 5 wherein the closed loop perforation line is substantially circular.

7. The feline pet care vessel of claim 6 wherein the closed loop perforation line comprises a finger pull aperture.

8. The feline pet care vessel of claim 1 wherein the first and second boxes have a plurality of inner surfaces, and further comprising a waterproof coating applied to said inner surfaces.

9. The feline pet care vessel of claim 1 further comprising a rectangular pad fitted for covering a wall selected from the group consisting of the first and second horizontal walls, wherein the rectangular pad abutts said selected wall.

10. The feline pet care vessel of claim 9 wherein the rectangular pad is composed of a waterproof material.

11. The feline pet care vessel of claim 1 further comprising cat litter overlying a wall selected from the group consisting of the first and second horizontal walls.
